(19) United States
(12) Patent Application Publication
(10) Pub. No.: US 2002/0145781 A1
(43) Pub. Date: Oct. 10, 2002

(54) Modular, re-configurable optical add/drop device for non-blocking, non-service-interrupting service

(76) Inventors: Derek Spock, Boston, MA (US); Vijayanand Vusirikala, Woburn, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 09/832,178

(22) Filed: Apr. 10, 2001

(51) Int. Cl. G02B 6/28; H04J 14/02

(52) U.S. Cl. 359/127; 385/24

(57) ABSTRACT

An optical add/drop multiplexor usable in a WDM optical communications system that can be re-configured to add and/or drop new arbitrarily selected wavelengths without adversely impacting added, dropped, or expressed traffic that is already provisioned. The optical add/drop multiplexor includes an optical add/drop module, an optical signal interleaver, and an optical signal de-interleaver. Re-configuration of the optical add/drop multiplexor is achieved by employing the optical signal interleaver to provide at least one arbitrarily selected wavelength, or combine a plurality of arbitrarily selected wavelengths, to generate added traffic provided to the optical add/drop multiplexor; and, by employing the optical signal de-interleaver to separate at least one arbitrarily selected wavelength from dropped traffic provided by the optical add/drop multiplexor.

### CROSS REFERENCE TO RELATED APPLICATIONS N/A

### STATEMENT REGARDING FEDERALLY SPONSORED RESEARCH OR DEVELOPMENT N/A

### BACKGROUND OF THE INVENTION

The present invention relates generally to the field of optical communications systems, and more specifically to a wavelength division multiplexed optical communications system including an optical add/drop multiplexor that can be re-configured without adversely impacting added, dropped, or expressed traffic.

Wavelength Division Multiplexed (WDM) optical communications systems typically employ optical add/drop multiplexors configured to insert (remove) optical signals having respective wavelengths into (from) a multi-wavelength optical signal. A conventional optical add/drop device is a four (4) optical fiber device, in which a first fiber comprises an “input path”, a second fiber comprises an “output path”, a third fiber comprises an “add path”, and a fourth fiber comprises a “drop path”. The input path is configured to carry a multiwavelength optical input signal, the output path is configured to carry a multi-wavelength optical output signal (“expressed traffic”), the add path is configured to carry optical signals with respective wavelengths that are to be inserted into the multi-wavelength optical input signal (“added traffic”), and the drop path is configured to carry optical signals with respective wavelengths that are removed from the multi-wavelength optical input signal (“dropped traffic”). In the conventional optical add/drop device, the added traffic may be the same as the dropped traffic; however, not all of the dropped traffic needs to be “added”.

One drawback of the conventional optical add/drop device is that it is typically only capable of receiving added traffic via the single fiber of the add path, and typically only capable of providing dropped traffic to the single fiber of the drop path. For this reason, an optical multiplexor is often coupled to the add path to allow specific wavelengths to be combined to generate the added traffic. Similarly, an optical de-multiplexor is often coupled to the drop path to allow specific wavelengths to be separated from the dropped traffic.

One approach to providing optical multiplexing/de-multiplexing in a conventional optical add/drop device is to employ fixed optical filters configured to pass or block specific wavelengths. However, the use of fixed optical filters with optical add/drop devices can be problematic because such filters normally do not provide the wavelength selectivity required for arbitrarily selecting which wavelengths to combine to generate the added traffic, and for arbitrarily selecting which wavelengths to separate from the dropped traffic.

Further, combining arbitrarily selected wavelengths to generate added traffic, and separating arbitrarily selected wavelengths from dropped traffic, typically require the use of fixed optical filters configured to pass those wavelengths. However, such fixed optical filters may not be currently available in the installed WDM optical communications system, and may therefore have to be purchased and installed in the system. Having to purchase and install fixed optical filters in a WDM optical communications system to provide optical multiplexing/de-multiplexing functions for certain arbitrarily selected wavelengths can significantly increase the cost of operating the system.

Moreover, optical add/drop devices employing fixed optical filters typically cannot be easily re-configured to handle such arbitrarily selected wavelengths. As a result, prior wavelength planning is frequently required to assure that a WDM optical communications system provides service for a desired group of wavelengths.

Although tunable optical filters may alternatively be employed to provide optical multiplexing/de-multiplexing in optical add/drop devices, the use of such tunable technology may not provide an optimum range of wavelength selectivity, especially for WDM optical communications systems destined for use in high traffic metro-network markets. Further, tunable filters are typically two (2) port devices, and therefore have to be used in conjunction with a circulator to separate multiple wavelengths.

Moreover, the use of tunable fiber gratings in WDM optical communications systems may adversely impact added, dropped, or expressed traffic by, e.g., at least temporarily blocking or interrupting service for some wavelengths. For example, a tunable fiber grating coupled to the drop path of a conventional optical add/drop device may be tuned to separate a selected wavelength from dropped traffic. However, while the fiber grating is being tuned to provide such separation of wavelengths, the dropped traffic may pass through at least one intermediate state, in which the transmission of an optical wavelength is inadvertently blocked or interrupted. Such blocking or interrupting of service is generally unacceptable in a WDM optical communications system.

It would therefore be desirable to have a re-configurable optical add/drop multiplexor that can be used in a WDM optical communications system. Such an optical add/drop multiplexor would be re-configurable to add or drop arbitrarily selected wavelengths without adversely impacting the transmission of added, dropped, or expressed traffic.

### BRIEF SUMMARY OF THE INVENTION

In accordance with the present invention, an optical add/drop multiplexor usable in a WDM optical communications system is provided that can be re-configured to add and/or drop arbitrarily selected wavelengths without adversely impacting added, dropped, or expressed traffic. Such re-configuration of the optical add/drop multiplexor is achieved by employing an optical signal de-interleaver to separate at least one arbitrarily selected wavelength from dropped traffic, and by employing an optical signal interleaver to combine a plurality of arbitrarily selected wavelengths to generate added traffic.

In one embodiment, the optical add/drop multiplexor includes a re-configurable optical add/drop module coupled to at least four (4) optical fibers, in which a first fiber comprises an input path configured to carry a multi-wavelength optical input signal, a second fiber comprises an output path configured to carry expressed traffic, a third fiber comprises an add path configured to carry added traffic, and a fourth fiber comprises a drop path configured to carry dropped traffic. The re-configurable optical add/drop module has the capability of sending an arbitrary set of wavelengths to the express port (fiber), and sending remaining wavelengths to the drop port (fiber). Similarly, an arbitrary set of wavelengths can enter the module by way of the input port (fiber), and remaining wavelengths can enter the module by way of the add port (fiber). Because the optical add/drop module is re-configurable, the wavelength combinations in these arbitrary sets of wavelengths can be changed dynamically.

The optical signal interleaver is coupled to the add path. In a preferred embodiment, the optical signal interleaver has an architecture comprising a hierarchical arrangement of optical signal interleaver modules. Each optical signal interleaver module in the hierarchy is a three (3) port device including two (2) input ports configured to receive respective groups of wavelengths to be added, and a single output port configured to provide a combination of the respective groups of wavelengths received at the input ports.

The optical signal de-interleaver is coupled to the drop path. In a preferred embodiment, the optical signal de-interleaver has an architecture comprising a hierarchical arrangement of optical signal de-interleaver modules. Each optical signal de-interleaver module in the hierarchy is a three (3) port device including a single input port configured to receive a respective group of dropped wavelengths, and two (2) output ports configured to provide respective groups of wavelengths that are separated from the group of wavelengths received at the single input port.

By providing appropriate numbers of optical signal de-interleaver modules and optical signal interleaver modules in the respective hierarchical arrangements of the optical signal de-interleaver and the optical signal interleaver, the optical add/drop multiplexor can be re-configured to add and/or drop arbitrarily selected wavelengths without adversely impacting added, dropped, or expressed traffic. In this way, non-blocking/non-interrupting service can be achieved in WDM optical communications systems.

Other features, functions, and aspects of the invention will be evident from the Detailed Description of the Invention that follows.

### BRIEF DESCRIPTION OF THE SEVERAL VIEWS OF THE DRAWING

The invention will be more fully understood with reference to the following Detailed Description of the Invention in conjunction with the drawings of which:

FIG. 1a is a block diagram depicting an optical add/drop multiplexor configured to provide nonblocking/non-interrupting service, in accordance with the present invention;

FIG. 1b is a block diagram depicting an optical signal de-interleaver included in the optical add/drop multiplexor of FIG. 1a; and

FIG. 1c is a block diagram depicting an optical signal interleaver included in the optical add/drop multiplexor of FIG. 1a.

### DETAILED DESCRIPTION OF THE INVENTION

Methods and apparatus are disclosed for adding and/or dropping new arbitrarily selected wavelengths in a Wavelength Division Multiplexed (WDM) optical communications system without adversely impacting added, dropped, or expressed traffic that is already provisioned. In one embodiment, a re-configurable optical add/drop multiplexor is provided, in which optical multiplexing and de-multiplexing functions are performed by an optical signal de-interleaver and an optical signal interleaver, respectively. As discussed in greater detail below, the optical signal de-interleaver permits a plurality of arbitrarily selected wavelengths to be combined to generate traffic to be added to a multi-wavelength optical signal, and the optical signal interleaver permits at least one arbitrarily selected wavelength to be separated from traffic dropped from the multi-wavelength optical signal. Because the configurable optical add/drop multiplexor may be employed to add or drop arbitrarily selected wavelengths without adversely impacting added, dropped, or expressed traffic, non-blocking/non-interrupting service can be achieved in the WDM optical communications system.

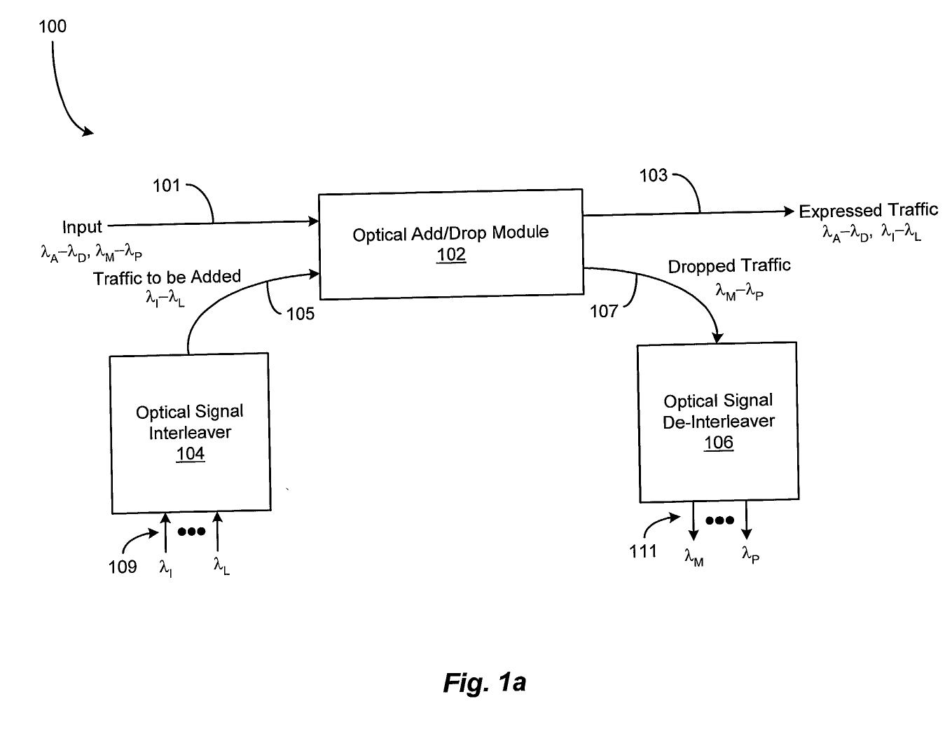

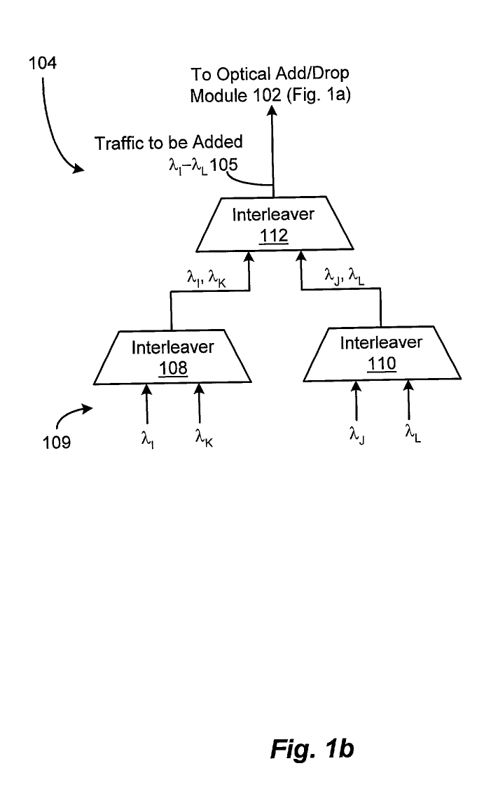

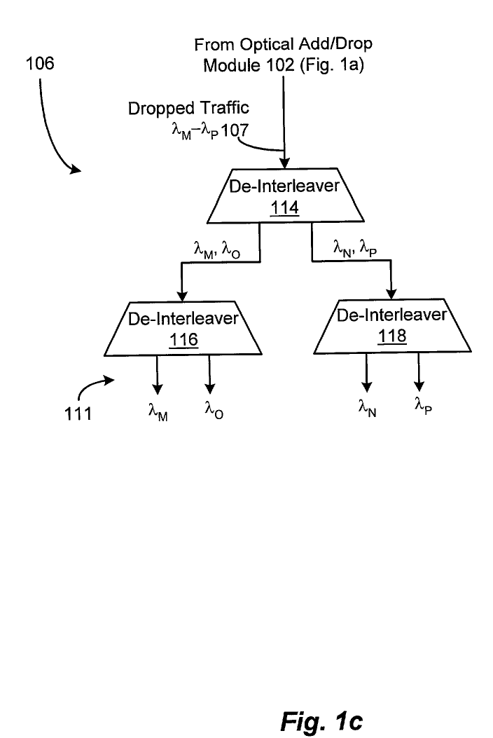

FIG. 1a depicts an illustrative embodiment of an optical add/drop multiplexor 100 configured to provide non-blocking/non-interrupting service in a WDM optical communications system, in accordance with the present invention. The optical add/drop multiplexor 100 includes an optical add/drop module 102, an optical signal interleaver 104, and an optical signal de-interleaver 106.

In the illustrated embodiment, the optical add/drop module 102 is coupled to four (4) optical fibers, in which a first fiber 101 comprises an “input path” configured to carry a multi-wavelength optical input signal, a second fiber 103 comprises an “output path” configured to carry expressed traffic, a third fiber 105 comprises an “add path” configured to carry added traffic, and a fourth fiber 107 comprises a “drop path” configured to carry dropped traffic.

The multi-wavelength optical input signal carried by the input path 101 includes a plurality of optical signals (also know as “carriers”) having respective wavelengths, e.g., λ_{A}-λ_{D}, λ_{M}-λ_{P}. Similarly, the traffic carried by the add path 105 includes a plurality of optical carriers with respective wavelengths, e.g., λ_{I}-λ_{L} The optical add/drop module 102 is configured to receive the multi-wavelength optical input signal carried by the input path 101 and the traffic carried by the add path 105, and insert the respective wavelengths λ_{I}-λ_{L} received via the add path 105 into the multi-wavelength optical input signal.

Further, the optical add/drop module 102 is configured to remove selected wavelengths, e.g., λ_{M}-λ_{P}, from the multi-wavelength optical input signal; and, provide the removed wavelengths λ_{M}-λ_{P} to the drop path 107 as dropped traffic. Moreover, the optical add/drop module 102 is configured to provide remaining wavelengths of the multi-wavelength optical signal, e.g., λ_{A}-λ_{D}, λ_{I}-λ_{L}, to the output path 103 as expressed traffic to allow those wavelengths to pass through to subsequent nodes of the WDM optical communications system.

For example, the optical add/drop module 102 may comprise a CORNING™ optical add/drop module sold by CORNING, Inc., Endicott, N.Y., U.S.A., or any other suitable optical add/drop module capable of inserting (removing) individual optical carriers of different wavelengths into (from) a multi-wavelength optical signal. Further, the input path 101, the output path 103, the add path 105, and the drop path 107 may comprise respective single mode optical transmission fibers.

In the illustrated embodiment, the optical signal interleaver 104 provides the respective wavelengths λ_{I}-λ_{L} to the optical add/drop module 102 by way of the add path 105. The optical signal interleaver 104 is coupled to a plurality of optical fibers 109 configured to carry the respective wavelengths λ_{I}-λ_{L}, and the add path 105 configured to carry the added traffic comprising the wavelengths λ_{I}-λ_{L}. For example, the optical signal interleaver 104 may receive a plurality of arbitrarily selected wavelengths by way of the plurality of fibers 109, combine the arbitrarily selected wavelengths to generate the traffic to be added to the multi-wavelength optical input signal, and provide the generated traffic to the optical add/drop module 102 via the add path 105. In this way, arbitrarily selected wavelengths may be provided to the optical add/drop module 102 for subsequent insertion into the multi-wavelength optical input signal.

In the illustrated embodiment, the optical signal de-interleaver 106 receives the respective wavelengths λ_{M}-λ_{P} of the dropped traffic from the optical add/drop module 102. The optical signal de-interleaver 106 is coupled to the drop path 107 configured to carry the dropped traffic comprising the wavelengths λ_{M}-λ_{P}, and a plurality of optical fibers 111 configured to carry at least one of the respective wavelengths λ_{M}-λ_{P}. For example, the optical signal de-interleaver 106 may receive the dropped traffic by way of the drop path 107, separate a plurality of arbitrarily selected wavelength from the dropped traffic, and provide the arbitrarily selected wavelengths to the respective fibers 111. In this way, arbitrarily selected wavelengths may be separated from the dropped traffic received from the optical add/drop module 102.

FIG. 1b depicts an illustrative embodiment of the optical signal interleaver 104 included in the optical add/drop multiplexor 100 (see FIG. 1a). In a preferred embodiment, the optical signal interleaver 104 includes a hierarchical arrangement of optical signal interleaver modules. In the illustrated embodiment, the optical signal interleaver 104 includes a plurality of optical signal interleaver modules 108 and 110 disposed in a lower level of the hierarchical arrangement, and a single optical signal interleaver module 112 disposed in an upper level of the hierarchical arrangement.

It should be understood that the optical signal interleaver 104 may comprise a hierarchical arrangement of optical signal interleaver modules that includes any suitable number of levels for combining arbitrarily selected wavelengths to generate added traffic. The number of levels in the interleaver hierarchy may be determined by the density of the wavelength plan, and the flexibility and granularity required at the add port. The hierarchical arrangement of optical signal interleaver modules 108, 110, and 112 includes the two (2) upper and lower levels of modules, as shown FIG. 1b, for clarity of discussion.

Each of the optical signal interleaver modules 108, 110, and 112 comprises three (3) ports, including two (2) input ports configured to receive respective groups of wavelengths, and a single output port configured to provide a combination of the respective groups of wavelengths received at the input ports. Specifically, the optical signal interleaver module 108 includes two (2) input ports for receiving the respective wavelengths λ_{I} and λ_{K}, and a single output port for providing a multiwavelength optical signal comprising the wavelengths λ_{I}, λ_{K}.

Similarly, the optical signal interleaver module 110 includes two (2) input ports for receiving the respective wavelengths λ_{J} and λ_{L}, and a single output port for providing a multi-wavelength optical signal comprising the wavelengths λ_{J}, λ_{L}; and, the optical signal interleaver module 112 includes two (2) input ports for receiving the respective multi-wavelength optical signals provided at the output ports of the modules 108 and 110, and a single output port for providing a multi-wavelength optical signal comprising the wavelengths λ_{I}, λ_{J}, λ_{K}, and λ_{L}.

For example, the wavelengths λ_{I}, λ_{J}, λ_{K}, and λ_{L} may comprise a set of International Telecommunication Union (ITU) standard WDM wavelengths. Further, the optical signal interleaver module 108 may be employed to combine an “even” group of wavelengths λ_{I} and λ_{K} (in which “even” refers to wavelengths on the ITU grid), the optical signal interleaver module 110 may be employed to combine an “odd” group of wavelengths λ_{J} and λ_{L} (in which “odd” refers to wavelengths 50 GHz offset from the ITU grid), and the optical signal interleaver module 112 may be employed to combine the even and odd groups of wavelengths into a single set of wavelengths λ_{I}, λ_{J}, λ_{K}, and λ_{L}.

It is noted that such processing of wavelengths in even and odd groups can simplify the interface between the device(s) (not shown) providing the respective wavelengths λ_{I}, λ_{J}, λ_{K}, and λ_{L} to the optical signal interleaver 104, and the optical add/drop module 102 (see FIG. 1a), which may be designed to handle different wavelength spacings. For example, the device(s) providing the respective wavelengths λ_{I}, λ_{J}, λ_{K} and λ_{L} may be designed to handle wavelengths with spacings of 400 GHz, and the optical add/drop module 102 may be designed to handle wavelengths with spacings of 100 GHz. Accordingly, the device(s) may provide the respective wavelengths λ_{I}, λ_{J},λ_{K}, and λ_{L} to the optical signal interleaver modules 108 and 110 with the 400 GHz spacing, the optical signal interleaver modules 108 and 110 may provide the respective even and odd groups of wavelengths to the optical signal interleaver module 112 with a 200 GHz spacing, and the optical signal interleaver module 112 may provide the added traffic comprising the single set of wavelengths λ_{I}, λ_{J}, λ_{K}, and λ_{L} to the optical add/drop module 102 with the 100 GHz spacing.

It should also be noted that the number of groups of wavelengths provided to the respective input ports of the optical signal interleaver modules at each level of the hierarchy are congruent modulo the number of optical signal interleaver modules that process those wavelengths. For example, the four (4) groups of wavelengths λ_{I}, λ_{J}, λ_{K}, and λ_{L} provided to the respective input ports of the modules 108 and 110, and the two (2) groups of wavelengths λ_{I}, λ_{J} and λ_{K}, λ_{L} provided to the respective input ports of the module 112, are congruent modulo the three (3) modules 108, 110, and 112, and the single module 112, respectively (i.e., 4 mod 3=2 mod 1).

FIG. 1c depicts an illustrative embodiment of the optical signal de-interleaver 106 included in the optical add/drop multiplexor 100 (see FIG. 1a). In a preferred embodiment, the optical signal de-interleaver 106 includes a hierarchical arrangement of optical signal interleaver modules. In the illustrated embodiment, the optical signal de-interleaver 106 includes a plurality of optical signal de-interleaver modules 116 and 118 disposed in a lower level of the hierarchical arrangement, and a single optical signal de-interleaver module 114 disposed in an upper level of the hierarchical arrangement.

Like the optical signal interleaver 104, the optical signal de-interleaver 106 may comprise a hierarchical arrangement of modules that includes any suitable number of levels. The hierarchical arrangement of optical signal de-interleaver modules 114, 116, and 118 includes the two (2) upper and lower levels of modules, as shown in FIG. 1c, for clarity of discussion.

Each of the optical signal de-interleaver modules 114, 116, and 118 comprises three (3) ports, including a single input port configured to receive a multi-wavelength optical signal, and two (2) output ports configured to provide respective groups of wavelengths separated from the multi-wavelength optical signal received at the input port. Specifically, the optical signal de-interleaver module 114 includes a single input port for receiving the wavelengths λ_{M}, λ_{N}, λ_{O}, and λ_{P}; and, two (2) output ports for providing respective groups of wavelengths λ_{M}, λ_{O} and λ_{N}, λ_{P}Similarly, the optical signal de-interleaver module 116 includes a single input port for receiving the group of wavelengths λ_{M}, λ_{O}, and two (2) output ports for providing the respective wavelengths λ_{M} and λ_{O}; and, the optical signal de-interleaver module 118 includes a single input port for receiving the group of wavelengths λ_{N}, λ_{P}, and two (2) output ports for providing the respective wavelengths λ_{N} and λ_{P}.

Like the wavelengths λ_{I}, λ_{J}, 80 _{K}, and λ_{L}, the wavelengths λ_{M}, λ_{N}, λ_{O}, and λ_{P} may comprise a set of ITU standard WDM wavelengths. Further, the optical signal de-interleaver module 114 may be employed to receive the set of wavelengths λ_{M}, λ_{N}, λ_{O}, and λ_{P}, and separate them into an even group of wavelengths λ_{M} and λ_{O} and an odd group of wavelengths λ_{N} and λ_{P}. Similarly, the optical signal de-interleaver module 116 may be employed to receive the even group of wavelengths λ_{M}, λ_{O}, and provide the respective wavelengths λ_{M} and λ_{O} at its output ports; and, the optical signal de-interleaver module 118 may be employed to receive the odd group of wavelengths λ_{N}, λ_{P}, and provide the respective wavelengths λ_{N} and λ_{P} at its output ports.

Such processing of wavelengths in even and odd groups can simplify the interface between the optical add/drop module 102 (see FIG. 1a) and the device(s) (not shown) receiving the respective wavelengths λ_{M}, λ_{O}, λ_{N}, and λ_{P}, which may be designed for different wavelength spacings. For example, the device(s) receiving the respective wavelengths λ_{M}, λ_{O}, λ_{N}, and λ_{P} may be designed for wavelengths with spacings of 400 GHz, and the optical add/drop module 102 may be designed for wavelengths with spacings of 100 GHz. Accordingly, the optical add/drop module 102 may provide the wavelengths λ_{M}, λ_{N}, λ_{O}, and λ_{P} comprising the dropped traffic to the optical signal deinterleaver module 114 with the 100 GHz spacing, the optical signal de-interleaver module 114 may provide the respective even and odd groups of wavelengths to the optical signal de-interleaver modules 116 and 118 with a 200 GHz spacing, and the optical signal de-interleaver modules 116 and 118 may generate the respective wavelengths λ_{M}, λ_{O}, λ_{N}, and λ_{P} with the 400 GHz spacing.

It is noted that the number of groups of wavelengths provided at the respective output ports of the optical signal de-interleaver modules at each level of the hierarchy are congruent modulo the number of optical signal de-interleaver modules that process those wavelengths. For example, the four (4) groups of wavelengths λ_{M}, λ_{O}, λ_{N}, and λ_{P} provided at the respective output ports of the modules 116 and 118, and the two (2) groups of wavelengths λ_{M}, λ_{O} and λ_{N}, λ_{P} provided at the respective output ports of the module 114, are congruent modulo the three (3) modules 114, 116, and 118, and the single module 114, respectively (i.e., 4 mod 3=2 mod 1).

It should be understood that the modules 108, 110, and 112 (see FIG. 1b), and the modules 114, 116, and 118 (see FIG. 1c), may be in the form of optical signal interleavers and optical signal de-interleavers, respectively, or any other device capable of performing the functions attributable to the respective modules, as described herein.

By providing predetermined numbers of levels, and corresponding numbers of modules, in the respective hierarchical arrangements of the optical signal interleaver 104 and the optical signal de-interleaver 106, an optimum range of wavelength selectivity can be achieved in the optical add/drop multiplexor 100 (see FIG. 1a). It is noted that the numbers of levels in the respective hierarchical arrangements may be determined relative to the numbers of carrier wavelengths in the added traffic and the dropped traffic processed by the optical signal interleaver 104 and the optical signal de-interleaver 106, respectively.

It should also be noted that the optical add/drop module 102 need not interface with the optical signal interleaver 104 and the optical signal de-interleaver 106 only at the uppermost levels of the respective hierarchies of modules, but may instead access carrier wavelengths at any selected level of the respective hierarchies. Similarly, the device(s) providing carrier wavelengths to the optical signal interleaver 104, and the device(s) receiving carrier wavelengths from the optical signal de-interleaver 106, may access carrier wavelengths at any selected level of the respective hierarchies. By accessing carrier wavelengths at any selected level of the respective module hierarchies, the optical add/drop multiplexor 100 may be re-configured without having to install or remove individual optical signal de-interleaver modules and/or optical signal interleaver modules. Further, such re-configuration is achieved without interrupting or blocking any carrier wavelengths processed by the optical signal de-interleaver and interleaver modules.

It will further be appreciated by those of ordinary skill in the art that modifications to and variations of the above-described methods and apparatus may be made without departing from the inventive concepts disclosed herein. Accordingly, the invention should not be viewed as limited except as by the scope and spirit of the appended claims.

What is claimed is:

1. An optical add/drop multiplexor comprising:
an optical add/drop module configured to (1) receive a multi-wavelength optical input signal from an input path, (2) provide a multi-wavelength optical output signal to an output path, and (3) provide dropped traffic comprising at least one dropped wavelength to a first drop path, the dropped traffic being removed from the multi-wavelength optical input signal; and
an optical signal de-interleaver coupled between the first drop path and a second drop path, the optical signal de-interleaver being configured to (1) receive the dropped traffic from the first drop path, (2) separate at least one selected dropped wavelength from the dropped traffic, and (3) provide the selected dropped wavelength to the second drop path for subsequent processing.

2. The optical add/drop multiplexor of claim 1, wherein the optical signal de-interleaver has an architecture comprising a plurality of hierarchical levels, at least one optical signal de-interleaver module being disposed in each of the hierarchical levels.

3. The optical add/drop multiplexor of claim 2, wherein the at least one optical signal de-interleaver module disposed in each of the hierarchical levels includes a single input port configured to receive an optical signal comprising at least one dropped wavelength, and a plurality of output ports configured to provide respective groups of dropped wavelengths.

4. The optical add/drop multiplexor of claim 2, wherein the at least one optical signal de-interleaver module disposed in each of the hierarchical levels includes a single input port configured to receive an optical signal comprising at least one dropped wavelength, and two output ports configured to provide respective groups of dropped wavelengths including a group of even wavelengths and a group of odd wavelengths.

5. The optical add/drop multiplexor of claim 1, wherein the input path, the output path, the first drop path, and the second drop path each comprise a respective single mode optical transmission fiber.

6. The optical add/drop multiplexor of claim 1 further including a tunable optical filter coupled to the optical signal de-interleaver by way of the second drop path, the tunable optical filter being configured to de-multiplex the selected dropped wavelength provided to the second drop path by the optical signal de-interleaver.

7. An optical add/drop multiplexor comprising:
an optical add/drop module configured to (1) receive a multi-wavelength optical input signal from an input path, (2) provide a multi-wavelength optical output signal to an output path, and (3) receive add traffic including at least one selected add wavelength from a first add path, the add traffic to be inserted into the multi-wavelength optical input signal; and
an optical signal interleaver coupled between the first add path and a second add path and configured to (1) receive the at least one selected add wavelength from the respective second add path, (2) in the event the at least one selected add wavelength comprises a plurality of selected add wavelengths, combine the plurality of selected add wavelengths to generate the add traffic, and (3) provide the add traffic to the optical add/drop module by way of the first add path for subsequent processing.

8. The optical add/drop multiplexor of claim 7, wherein the optical signal interleaver has an architecture comprising a plurality of hierarchical levels, at least one optical signal interleaver module being disposed in each of the hierarchical levels.

9. The optical add/drop multiplexor of claim 8, wherein the at least one optical signal interleaver module disposed in each of the hierarchical levels includes a plurality of input ports configured to receive respective groups of add wavelengths, and a single output port configured to provide an optical signal comprising the received add wavelengths.

10. The optical add/drop multiplexor of claim 8, wherein the at least one optical signal interleaver module disposed in each of the hierarchical levels includes two input ports configured to receive respective groups of add wavelengths including a group of even wavelengths and a group of odd wavelengths, and a single output port configured to provide an optical signal comprising the even and odd wavelengths.

11. The optical add/drop multiplexor of claim 7, wherein the input path, the output path, the first add path, and the second add path each comprise a respective single mode optical transmission fiber.

12. The optical add/drop multiplexor of claim 7 further including a tunable laser coupled to the optical signal interleaver via the second add path, the tunable laser being configured to provide the at least one selected add wavelength to the optical signal interleaver via the second add path.

13. A method of receiving at least one selected dropped wavelength in a wavelength division multiplexed optical communications system, comprising the steps of:
receiving a multi-wavelength optical input signal from an input path by an optical add/drop device;
providing dropped traffic comprising at least one dropped wavelength to a first drop path by the optical add/drop device, the dropped traffic being removed from the multi-wavelength optical input signal;
receiving the dropped traffic from the first drop path by an optical signal de-interleaver device;
separating the at least one selected dropped wavelength from the dropped traffic by the optical signal de-interleaver device; and
providing the selected dropped wavelength to a second drop path by the optical signal de-interleaver device for subsequent processing.

14. The method of claim 13, wherein the separating step includes, in the event the at least one selected dropped wavelength comprises a plurality of selected dropped wavelengths, separating the plurality of selected dropped wavelengths from the dropped traffic by the optical signal de-interleaver device to generate a group of even wavelengths and a group of odd wavelengths, and wherein the second providing step includes providing the respective groups of even and odd wavelengths to the second drop path by the optical signal de-interleaver device for subsequent processing.

15. A method of providing at least one selected add wavelength to be inserted into a multi-wavelength optical signal in a wavelength division multiplexed optical communications system, comprising the steps of:
receiving the at least one selected add wavelength from a first add path by an optical signal interleaver device;
in the event the at least one selected add wavelength comprises a plurality of selected add wavelengths, combining the plurality of selected add wavelengths to generate add traffic by the optical signal interleaver device; and
providing the add traffic to an optical add/drop device via a second add path by the optical signal interleaver device for subsequent insertion into the multi-wavelength optical signal.

16. The method of claim 15 wherein the receiving step includes receiving respective groups of selected add wavelengths including a group of even wavelengths and a group of odd wavelengths from the first add path by the optical signal interleaver device, and wherein the combining step includes combining the respective groups of even and odd wavelengths to generate the add traffic by the optical signal interleaver device.
